(19) United States
(12) Patent Application Publication
(10) Pub. No.: US 2005/0177478 A1
(43) Pub. Date: Aug. 11, 2005

(54) Method and system for managing promotional telematics services

(75) Inventor: William E. Mazzara JR., Drayton Plains, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/736,491

(22) Filed: Dec. 15, 2003

(51) Int. Cl. G06F 17/60

(52) U.S. Cl. 705/34

(57) ABSTRACT

The present invention provides a method for managing promotional telematics services within a telematics equipped mobile vehicle. The method includes receiving a request to initiate at least one telematics service, determining if the at least one requested telematics service is associated with a special billing plan, and implementing the special billing plan responsive to the determination. The method may further include operating the telematics unit within the at least one requested telematics service. The step of implementing the special billing plan responsive to the determination may include determining if a remaining special time value of the special billing plan is not equal to zero, decrementing the remaining special time value when the remaining time value is not equal to zero, and incrementing a special billing time value when the remaining time value is zero. The remaining time value may be a predetermined time value.

### FIELD OF THE INVENTION

This invention relates generally to wireless communications with a mobile vehicle. More specifically, the invention relates to a method and system for managing promotional telematics services within a telematics equipped vehicle.

### BACKGROUND OF THE INVENTION

The opportunity to utilize wireless features in a mobile vehicle is ever increasing as the automobile is being transformed into a communications and entertainment platform as well as a transportation platform. Wireless features include wireless vehicle communication, networking, maintenance and diagnostic services for a mobile vehicle.

Typically, conventional wireless systems within mobile vehicles (e.g. telematics units) provide voice communication. Recently, these wireless systems have been utilized to update systems within telematics units, such as, for example radio station presets. Other systems within mobile vehicles, such as, for example a power train control may be updated as well. Information may also be collected from systems and subsystems within mobile vehicles and provided to a vehicle manufacturer for analysis, such as, for example system usage, component wear, and the like.

The present invention advances the state of the art.

### SUMMARY OF THE INVENTION

One aspect of the invention includes a method for operating a telematics unit within a mobile vehicle including receiving a request to initiate at least one telematics service, determining if the at least one requested telematics service is associated with a special billing plan, and implementing the special billing plan responsive to the determination.

In accordance with another aspect of the invention, a computer readable medium storing a computer program includes: computer readable code for processing a request to initiate at least one telematics service; computer readable code for determining if the at least one requested telematics service is associated with a special billing plan; and computer readable code for implementing the special billing plan responsive to the determination.

In accordance with yet another aspect of the invention, a system for operating a telematics unit within a mobile vehicle is provided. The system includes means for receiving a request to initiate at least one telematics service. Means for determining if the at least one requested telematics service is associated with a special billing plan is provided. Means for implementing the special billing plan responsive to the determination is also provided.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates an operating environment for implementing wireless communication within a mobile vehicle communication system;

FIG. 2 is a block diagram of telematics based programming gateway in accordance with an embodiment of the present invention,

FIG. 3 is a flow diagram of one embodiment of a method of managing promotional telematics services within a telematics equipped mobile vehicle, in accordance with the present invention; and

FIG. 4 is a flow diagram of another embodiment of a method of managing promotional telematics services within a telematics equipped mobile vehicle, in accordance with the present invention.

### DETAILED DESCRIPTION OF THE DRAWINGS

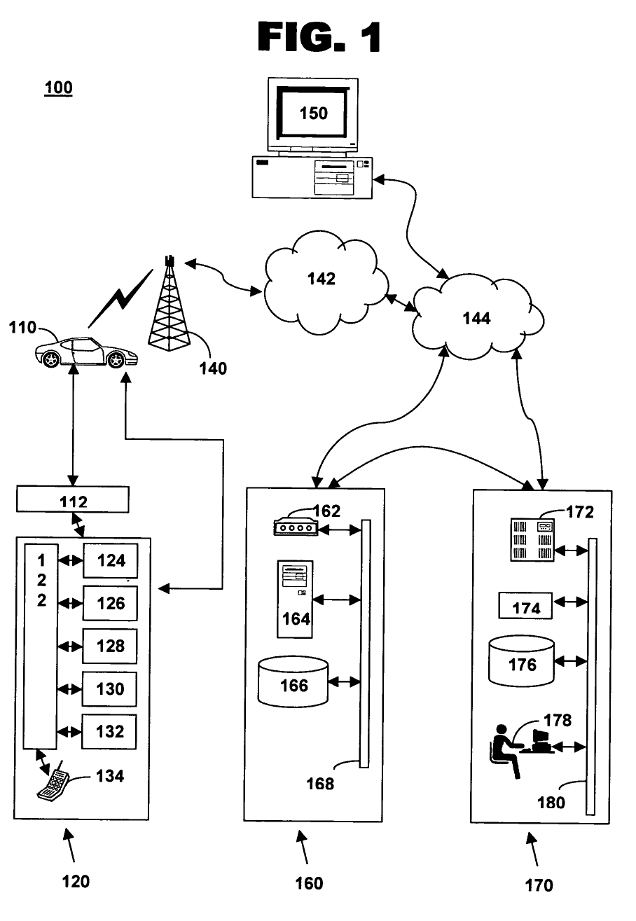

FIG. 1 illustrates one embodiment of system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a digital signal processor (DSP) 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components, such as, for example GPS unit 126 or speakers 132. Telematics unit 120 may include additional components not relevant to the present discussion.

In one embodiment, DSP 122 is implemented as a microcontroller, controller, host processor, or vehicle communications processor. In an example, DSP 122 is implemented as an application specific integrated circuit (ASIC). In another embodiment, DSP 122 is implemented as a processor working in conjunction with a central processing unit (CPU) performing the function of a general purpose processor. GPS unit 126 provides longitude and latitude coordinates of the vehicle responsive to a GPS broadcast signal received from a one or more GPS satellite broadcast systems (not shown). In-vehicle mobile phone 134 is a cellular-type phone, such as, for example an analog, digital, dual-mode, dual-band, multi-mode or multi-band cellular phone.

DSP 122 executes various computer programs that control programming and operational modes of electronic and mechanical systems within MVCU 110. DSP 122 controls communications (e.g. call signals) between telematics unit 120, wireless carrier system 140, and call center 170. In one embodiment, a voice-recognition application is installed in DSP 122 that can translate human voice input through microphone 130 to digital signals. DSP 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from DSP 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

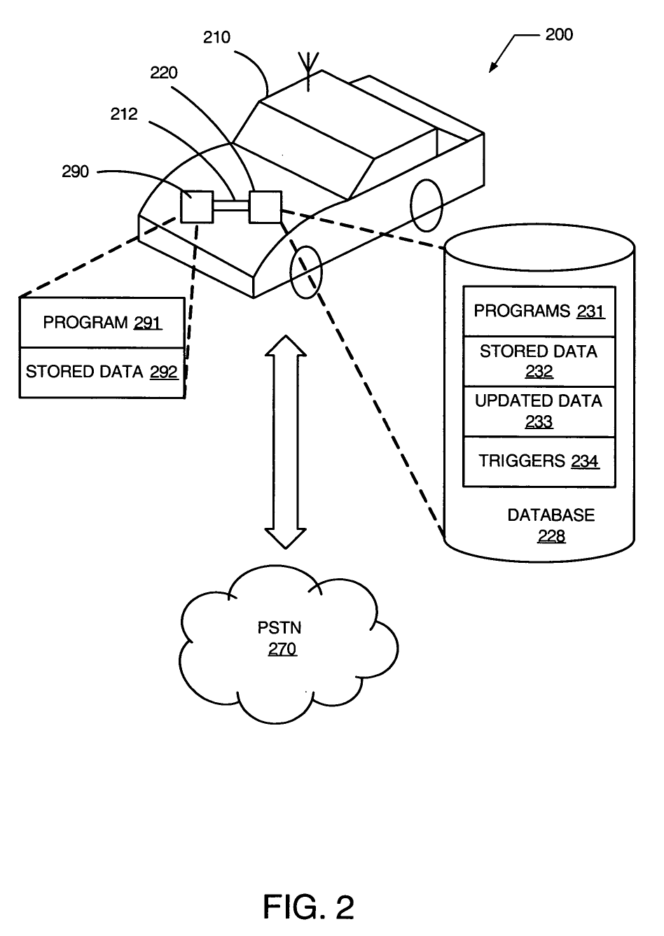

FIG. 2 is a block diagram of a telematics based programming gateway in accordance with an embodiment of the present invention. FIG. 2 shows a telematics system 200 for managing promotional telematics services within a telematics equipped mobile vehicle. In FIG. 2, the telematics system includes a mobile vehicle 210 having a telematics unit 220 coupled to one or more vehicle system modules 290 via a vehicle communication bus 212, and a communication network 270, such as, for example a public switched telephone network (PSTN). Telematics unit 220 further includes a database 228 that contains programs 231, stored data 232, updated data 233 and triggers 234. Vehicle system module (VSM) 290 further includes a program 291 and stored data 292. In one embodiment, VSM 290 is located within telematics unit 220 and communication bus 212 is implemented as a communication bus. In FIG. 2, the elements are presented for illustrative purposes and are not intended to be limiting. Telematics system 200 may include additional components not relevant to the present discussion.

Telematics unit 220 is any telematics device enabled for operation with a telematics service provider, such as, for example telematics unit 120 as described with reference to FIG. 1. Telematics unit 220 in vehicle 210 is in communication with communication network 270 (e.g. a “PSTN”). Telematics unit 220 includes volatile and non-volatile memory components for storing data and programs. In one embodiment, memory components in telematics unit 220 contain database 228.

Database 228 includes one or more programs 231 for operating telematics unit 220, such as, for example, for managing promotional telematics services within a telematics equipped mobile vehicle. A program module receives a request to initiate a telematics service from a user interface, such as, for example a voice-recognition application at updated data 233. In an example, the request to initiate a telematics service is cached within updated data 233. The request to initiate a telematics service is stored at stored data 232. In one embodiment, telematics unit 220 acts as a data cache for requests to initiate telematics services, caching any received request to initiate a telematics services that are provided to one or more vehicle system modules 290 for the telematics unit 220. In another embodiment, program 231 includes software for receiving a request to initiate a telematics service, determining if the requested telematics service is associated with a special billing plan, implementing the special billing plan responsive to the determination, and operating the telematics unit within the requested telematics service.

Vehicle system module (VSM) 290 is any vehicle system control module having software and hardware components for operating, controlling or monitoring one or more vehicle systems. In one embodiment, VSM 290 is a visual user interface, such as, for example a monitor capable of receiving and displaying video signals as is known in the art. In this embodiment, VSM 290 operates a promotional telematics service, such as, for example a mapping/direction finding service and displays the promotional telematics service via the visual user interface portion of VSM 290. In another embodiment, VSM 290 is a controller for controlling a vehicle system such as, for example, informational services, stock quotes, weather, traffic, shopping, sports scores, games, horoscopes and the like.

Vehicle system module 290 contains one or more processors, one or more memory devices and one or more connection ports. In one embodiment, VSM 290 includes a software switch for scanning received information, such as, for example user input to identify that data has been received. VSM 290 is coupled to a vehicle communication bus 212, and therefore to any other device that is also coupled to vehicle communication bus 212. The vehicle communication bus is also referred to as a vehicle communication network. In one embodiment, VSM 290 is directly coupled to telematics unit 220, such as, for example vehicle communication bus 212 coupling telematics unit 220 to vehicle system modules 290. In an example, vehicle communication bus 212 is a vehicle communication network 112 as described in FIG. 1, above. In another embodiment, VSM 290 is indirectly coupled to telematics unit 220.

VSM 290 includes one or more programs 291 and stored data 292 stored in memory. In one embodiment, program 291 includes software for receiving a request to initiate a telematics service and storing the received request to initiate a telematics service at stored data 292. In this embodiment, the received request is passed to telematics unit 220 for processing, such as, for example determining if the requested telematics service is associated with a special billing plan. If the requested telematics service is associated with a special billing plan, telematics unit 220 implements the special billing plan and instructs VSM 290 to operate any associated telematics services. In another embodiment, program 291 includes software for receiving a request to initiate a telematics service, determining if the requested telematics service is associated with a special billing plan, implementing the special billing plan responsive to the determination, and operating the telematics unit within the requested telematics service.

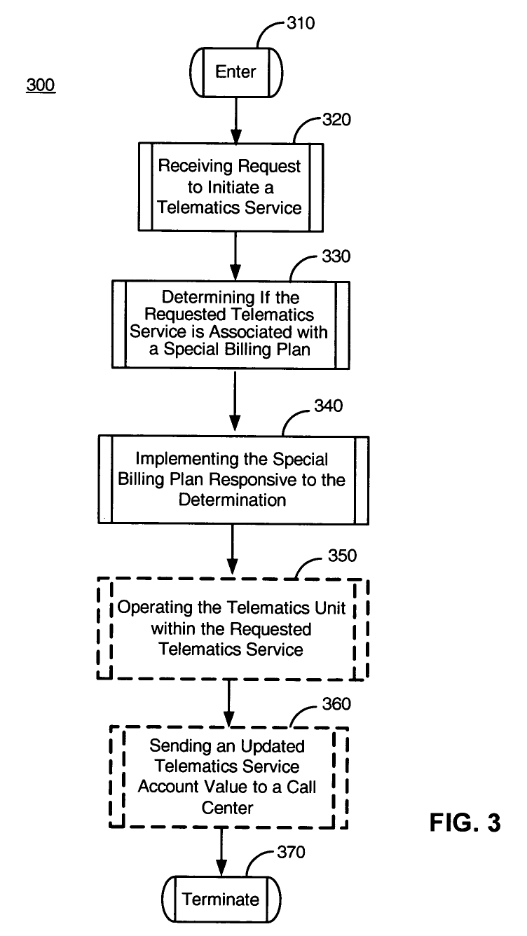

FIG. 3 is a flow diagram of an embodiment of a method of managing promotional telematics services within a telematics equipped mobile vehicle. In FIG. 3, method 300 may utilize one or more systems detailed in FIGS. 1 and 2, above. The present invention can also take the form of a computer usable medium including a program for configuring an electronic module within a vehicle. The program stored in the computer usable medium includes computer program code for executing the method steps described in FIG. 3. In FIG. 3, method 300 begins at step 310.

At step 320, a request to initiate at least one telematics service is received. In one embodiment, the requested telematics service is a promotional telematics service. Examples of telematics services include mapping/direction finding informational services, stock quotes, weather, traffic, shopping, sports scores, games, horoscopes and the like. In one embodiment, the request is received by a telematics unit, such as, for example telematics unit 220 of FIG. 2. In another embodiment, the request is received by a vehicle system module (VSM), such as, for example VSM 290 of FIG. 2.

At step 330, a determination as to if the at least one requested telematics service is associated with a special billing plan. If the determination is positive regarding an association between the requested telematics service and a special billing plan, then method 300 advances to step 340. In one embodiment, if the determination is negative regarding an association between the requested telematics service and a special billing plan, then a standard billing plan is implemented. In an example, the special billing plan determination identifies a particular special billing plan based on specific conditions, such as, the number dialed, the geographic location of the telematics device when the determination is made, and the like. In another example, an initial determination may produce a negative determination regarding an association between the requested telematics service and a special billing plan. In this example, a later determination may produce a positive determination regarding an association between the requested telematics service and a special billing plan, such as, accessing a premium telematics service, the time limit for a promotional service is exceeded, and the like.

At step 340, a special billing plan is implemented responsive to the determination. In one embodiment, implementing the special billing plan responsive to the determination includes determining if a remaining special time value of the special billing plan is not equal to zero, decrementing the remaining special time value when the remaining time value is not equal to zero, and incrementing a special billing time value when the remaining time value is zero. In an example, the remaining time value is a predetermined time value. In an example, the remaining special time value and the special billing time value are values expressed in time units, such as, hours, minutes and seconds. In another example, the remaining special time value and the special billing time value are values expressed as a number of times a particular service has been requested/implemented. In yet another example and referring to FIG. 2 above, the special billing plan is implemented within VSM 290 as described above. In another example, the special billing plan is implemented within telematics unit 220 and telematics unit 220 instructs VSM 290 to operate the requested telematics service.

In another embodiment, if a remaining special time value of the special billing plan is not equal to zero, a reminder message is sent to a user interface informing a user of the remaining special time value of the special billing plan. In this embodiment, the user can be solicited for user feedback, subscription, and the like.

In yet another embodiment, when the remaining time value is zero, a reminder message is sent to the user interface informing the user the remaining time value is zero. In this embodiment, the user can be solicited for user feedback, subscription, and the like.

At optional step 350, the telematics unit is operated within the requested telematics service. At optional step 360, an updated telematics service account value is sent to a call center. Examples of an updated telematics service account value include a special time value and a special billing time value. In an example and referring to FIG. 2 above, telematics unit 220 sends the updated telematics service account value to a call center via communication network 270 (e.g. a “PSTN”).

At step 370, the method ends.

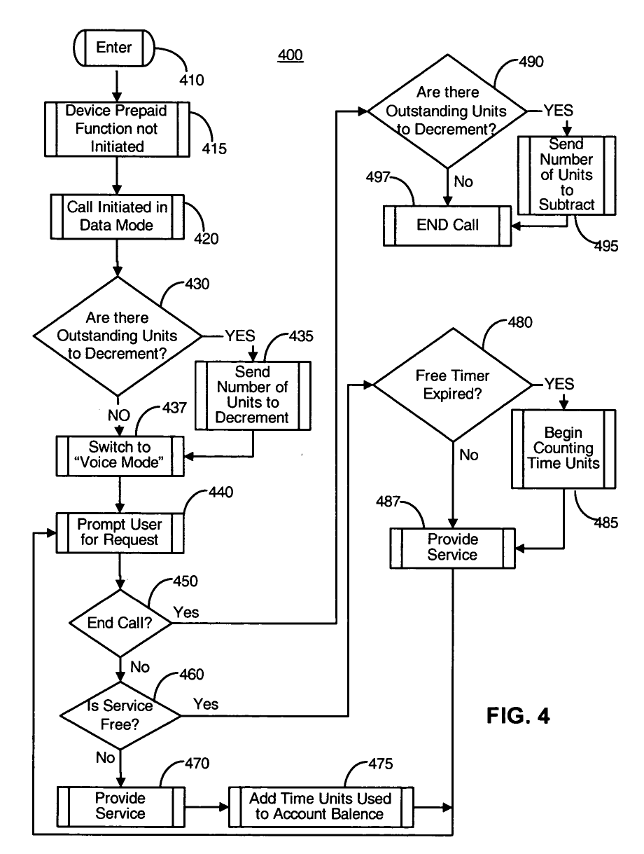

FIG. 4 is a flow diagram of another embodiment of a method of managing promotional telematics services within a telematics equipped mobile vehicle. In FIG. 4, method 400 may utilize one or more systems detailed in FIGS. 1 and 2, above. The present invention can also take the form of a computer usable medium including a program for configuring an electronic module within a vehicle. The program stored in the computer usable medium includes computer program code for executing the method steps described in FIG. 4. In FIG. 4, method 400 begins at step 410.

At step 415, the telematics unit ensures a prepaid function is not initiated. In one embodiment, the telematics unit ensures the prepaid function within the telematics unit is not initiated.

At step 420, the call is initiated in data mode. At decision step 430, a determination is made as to if there are outstanding service provider units to decrement. In one example, the outstanding service provider units result from a previous session. If there are outstanding service provider units to decrement, method 400 advances to step 435. If there are not outstanding service provider units to decrement, method 400 advances to step 437.

At step 435, the number of units to decrement is sent to an accounting device, such as, for example the telematics unit. At step 437, the telematics unit is switched to voice mode.

At step 440, a user is prompted for a request. In one embodiment, the user is prompted utilizing a user interface, such as, for example a video user interface, an audio user interface, and the like.

At decision step 450, an end of call determination is made. If the call is ended, method 400 advances to decision step 490. If the call is not ended, method 400 advances to step 460. At decision step 460, a determination is made as to if the user request is a free service, such as, for example a promotional service. If the requested service is free, method 400 advances to decision step 480. If the requested service is not free, method 400 advances to step 470.

At step 470, the service is provided. In one embodiment, the service is a charged standard voice call. At step 475, time units utilized are added to an account balance based on the service provided. Method 400 then returns to step 440.

At decision step 480, a determination is made as to if a free timer associated with the free service has expired. If the free timer associated with the free service has expired, method 400 advances to step 485. If the free timer associated with the free service has not expired, method 400 advances to step 487. At step 485, the free timer associated with the free service begins counting time units. At step 487, the service is provided. Method 400 then returns to step 440.

At decision step 490, a determination is made as to if there are outstanding units to decrement from an account balance. If there are outstanding units to decrement from an account balance, method 400 advances to step 495. If there are not outstanding units to decrement from an account balance, method 400 advances to step 497. At step 495, the number of units utilized is sent to an accounting device to decrement from the previous balance, such as, for example the telematics unit. At step 497, the call is terminated.

The above-described methods and implementation for managing promotional telematics services within a telematics equipped mobile vehicle are example methods and implementations. These methods and implementations illustrate one possible approach for managing promotional telematics services within a telematics equipped mobile vehicle. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its spirit or essential characteristics. The described embodiments are to be considered in all respects only as illustrative and not restrictive.

1. A method for operating a telematics unit within a mobile vehicle, the method comprising:
receiving a request to initiate at least one telematics service;
determining if the at least one requested telematics service is associated with a special billing plan; and
implementing the special billing plan responsive to the determination.

2. The method of claim 1, further comprising:
operating the telematics unit within the at least one requested telematics service.

3. The method of claim 1, wherein implementing the special billing plan responsive to the determination comprises:
determining if a remaining special time value of the special billing plan is not equal to zero;
decrementing the remaining special time value when the remaining time value is not equal to zero; and
incrementing a special billing time value when the remaining time value is zero.

4. The method of claim 3, wherein the remaining time value is a predetermined time value.

5. The method of claim 1, wherein requested telematics service is a promotional service.

6. The method of claim 1, further comprising:
implementing a standard billing plan when the determination is negative.

7. The method of claim 1, further comprising:
determining a transmission mode of the telematics unit.

8. The method of claim 7, wherein the transmission mode is selected from the group consisting of: a data mode and a voice mode.

9. The method of claim 1, further comprising:
sending an updated telematics service account value to a call center.

10. The method of claim 9, wherein the updated telematics service account value is selected from the group consisting of: a special time value and a special billing time value.

11. A computer readable medium for operating a telematics unit within a mobile vehicle, comprising:
computer readable code for processing a request to initiate at least one telematics service;
computer readable code for determining if the at least one requested telematics service is associated with a special billing plan; and
computer readable code for implementing the special billing plan responsive to the determination.

12. The computer readable medium of claim 11, further comprising:
computer readable code for operating the telematics unit within the at least one requested telematics service.

13. The computer readable medium of claim 11, wherein the computer readable code for implementing the special billing plan responsive to the determination comprises:
computer readable code for determining if a remaining special time value of the special billing plan is not equal to zero;
computer readable code for decrementing the remaining special time value when the remaining time value is not equal to zero; and
computer readable code for incrementing a special billing time value when the remaining time value is zero.

14. The computer readable medium of claim 13, wherein the remaining time value is a predetermined time value.

15. The computer readable medium of claim 11, wherein requested telematics service is a promotional service.

16. The computer readable medium of claim 11, further comprising:
computer readable code for implementing a standard billing plan when the determination is negative.

17. The computer readable medium of claim 11, further comprising:
computer readable code for determining a transmission mode of the telematics unit.

18. The computer readable medium of claim 17, wherein the transmission mode is selected from the group consisting of: a data mode and a voice mode.

19. The computer readable medium of claim 11, further comprising:
computer readable code for sending an updated telematics service account value to a call center.

20. The computer readable medium of claim 11, wherein the updated telematics service account value is selected from the group consisting of: a special time value and a special billing time value.

21. A system for operating a telematics unit within a mobile vehicle, the system comprising:
means for receiving a request to initiate at least one telematics service;
means for determining if the at least one requested telematics service is associated with a special billing plan; and
means for implementing the special billing plan responsive to the determination.
